(19) United States
(12) Patent Application Publication
(10) Pub. No.: US 2023/0042927 A1
(43) Pub. Date: Feb. 9, 2023

(54) TACTILE FEEDBACK DEVICE FOR PRODUCING UNIFORM VIBRATION IN AN EFFECTIVE AREA

(71) Applicant: TOPRAY MEMS INC., Hsinchu City (TW)

(72) Inventors: Chin-Sung Liu, Hsinchu City (TW); Shin-Ter Tsai, Hsinchu City (TW); Hsiao-Ming Chien, Hsinchu City (TW)

(21) Appl. No.: 17/404,860

(22) Filed: Aug. 17, 2021

(30) Foreign Application Priority Data
Jul. 29, 2021 (TW) 110127971

(51) Int. Cl. G06F 3/01

(52) U.S. Cl. CPC G06F 3/016

(57) ABSTRACT

A tactile feedback device for producing uniform vibration in an effective area is provided, including: a substrate, a vibration motor, a frame, and a plurality of cushion pads; the vibration motor is fixed on the substrate at an off-center position and can vibrate back-and-forth in a first direction; the frame forms a plurality of bonding areas and at least a pair of cantilever beams, the cantilever beams are located on both sides of the first direction and parallel to a second direction, the second direction is perpendicular to the first direction, and the cantilever beams are partially fixed to the substrate; the cushion pads are fixed between the substrate and the bonding area; thereby, the tactile feedback of uniform vibration can be obtained when contacting each operation position of the substrate.

### BACKGROUND OF THE INVENTION

### 1. Field of the Invention

The present invention relates generally to a tactile feedback device, and more particularly, to a tactile feedback device applicable to a plurality of electronic devices such as touchpads, flat keyboards, and tablet computer boards, in order to obtain uniform vibration feedback.

### 2. The Prior Arts

Tactile feedback is a common function of electronic products, and is commonly used in various electronic devices such as touch pads, flat keyboards, and tablet computers. The concept of tactile feedback is to simulate traditional mechanical keyboards and mouses, and generate feedback during touch operations. The ideal tactile feedback effect is that no matter where the touch operation position is, the vibration feedback generated is the same or similar. As shown in FIG. 1, which is a schematic planar view of a preferred structure of such a tactile feedback device, a vibration motor 14 is disposed at the center of a substrate 11, and the vibration motor 14 is disposed on the back as a dotted line shown in the figure. The substrate 11 can be a touch panel, a flat keyboard, a touch screen of a tablet computer, and so on. Therefore, no matter where a finger or a touch interface (such as a pen) touches any operation position on the substrate 11, since the vibration source is located in the center, the tactile feedback that generates the vibration is similar.

FIGS. 2 and 3 show a planar view and an exploded view of another embodiment of the existing tactile feedback control device respectively. This type of tactile feedback device includes a substrate 11; a frame 12 for carrying the substrate 11; a plurality of the cushion pads 3 engaged between the frame 12 and the substrate 11, and a vibration motor 14 engaged to the substrate 11, the vibration motor 14 being able to generate repetitive vibration along the X-axis. In the tactile feedback device of this implementation, the center bottom surface of the substrate 11 must be provided with related wiring lines or the space below must be installed with other components, such as electronic parts and batteries. When the vibration motor 14 is energized, in addition to the original X-axis vibration, a Z-axis inertia momentum, such as angular acceleration a, will also be generated due to deviation from the center. Therefore, uneven vibration will occur at different operation positions on the substrate 11. The simulation of the actual operating state shows that, the vibration motor 14 provides repetitive vibration in the X direction, frequency: 250 Hz, the mass of the substrate 11 is about 45 g, and the vibration motor 14 is started under the condition of a voltage of 20V. The actual vibration inductance values of the 3×3 division of the substrate 11 can be obtained in Table 1 and Table 2:

Table 1 is a vibration sensing measurement table for each position after the substrate 11 is divided into nine-square grids.

TABLE 1
Acceleration (Gpeak-to-peak, 1G = 9.81 m/s²)

| | | |
|---|---|---|
| 2.82 | 2.59 | 2.61 |
| 5.92 | 5.45 | 5.18 |
| 9.32 | 9.72 | 9.57 |

As seen, the vibration perception of each operation position is not the same. The farther away from the vibration motor 14, the smaller the tactile feedback of the vibration felt.

Table 2 is the natural frequency table of the substrate 11, wherein X is X-axis, Y is Y-axis, Z is Z-axis, ROTX is rotation around the X-axis, ROTY is rotation around the Y-axis, and ROTZ is rotation around the Z-axis.

TABLE 2

| mode of vibration | frequency(Hz) |
|---|---|
| X | 250 |
| Y | 250 |
| Z | 406 |
| ROTX | 657 |
| ROTY | 716 |
| ROTZ | 397 |

The analysis of the above data shows that the rigidity of the 6 degrees of freedom of the device is less than 1K Hz (the stronger the rigidity, the higher the natural frequency), and the ROTZ that generates torque after the vibration motor 14 is biased is only about 400 HZ, which means that the ROTZ has poor rigidity. Therefore, the Z-axis inertia momentum will increase or decrease depending on the contact operation position. As shown in Table 1, the vibration will be uneven at different operation positions. To address the issue, the rigidity of the ROTZ must be strengthened to overcome the uneven vibration of the substrate 11 caused by torque.

### SUMMARY OF THE INVENTION

A primary objective of the present invention is to provide a tactile feedback device for producing uniform vibration in the effective area. Even though the vibration source is off the center position, the tactile feedback of uniform vibration can be obtained at each operation position.

To achieve the foregoing objectives, the present invention provides the following technical solutions:

The present invention is a tactile feedback device for producing uniform vibrations in an effective area, including: a substrate, a vibration motor, a frame, and a plurality of cushion pads; the vibration motor is fixed on the substrate at an off-center position and can vibrate back-and-forth in a first direction; the frame forms a plurality of bonding areas and at least a pair of cantilever beams, the cantilever beams are located on both sides of the first direction and parallel to a second direction, the second direction is perpendicular to the first direction, and the cantilever beams are partially fixed to the substrate; the cushion pads are fixed between the substrate and the bonding area.

In a preferred embodiment, the substrate is one of a touch panel, a flat keyboard, and a touch screen of a tablet computer.

In a preferred embodiment, the end of the cantilever beams away from the connection with the frame is an end region, and the end region is adhered to the substrate.

In a preferred embodiment, the cantilever beam also forms at least one neck section with a narrower width.

In a preferred embodiment, two of the cantilever beams are connected to the two opposite sides of the frame, and are arranged in reverse symmetry.

In a preferred embodiment, two cantilever beams are connected to the same side of the frame and are arranged symmetrically.

In a preferred embodiment, two pairs of cantilever beams are respectively connected to the frame and located on both sides along the first direction, and are symmetrically arranged.

In a preferred embodiment, the bonding areas are evenly and symmetrically distributed on the inner edge of the frame.

In summary, a tactile feedback device of the present invention that produces uniform vibration in an effective area is to dispose the cantilever beams perpendicular to the vibration direction of the vibration motor. The cantilever beams increase the rigidity, suppress the Z-axis rotational inertia, and can also maintain the frequency resonance effect required by the original vibration direction. Therefore, even if the vibration source deviates from the center position, each operating position can still obtain a uniform vibration tactile feedback, and no additional components or other complicated structures are required. As such, the present invention can maintain the original light and thin requirements, and achieve the required uniform vibration without increasing the manufacturing and production costs.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic planar view of a preferred structure of a tactile feedback device;

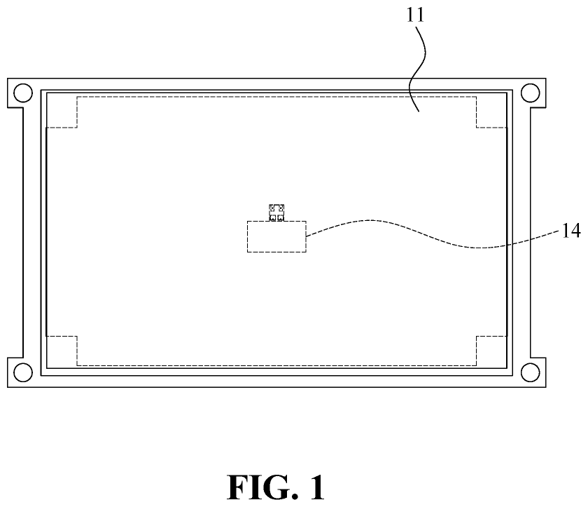

FIG. 2 is a planar view of another embodiment of a conventional tactile feedback device;

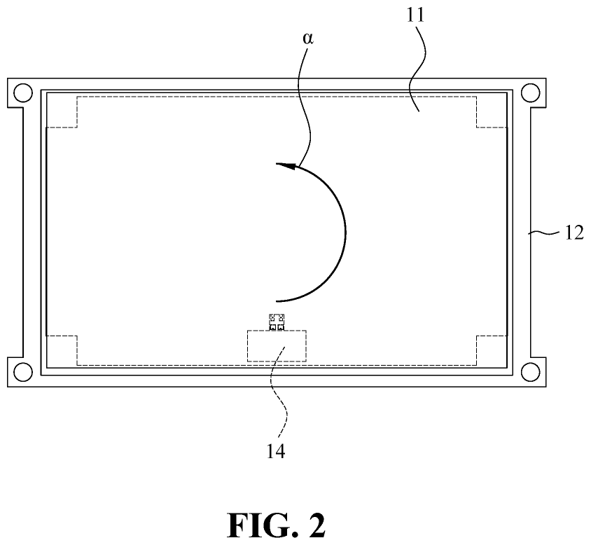

FIG. 3 is an exploded view of another embodiment of a conventional tactile feedback device;

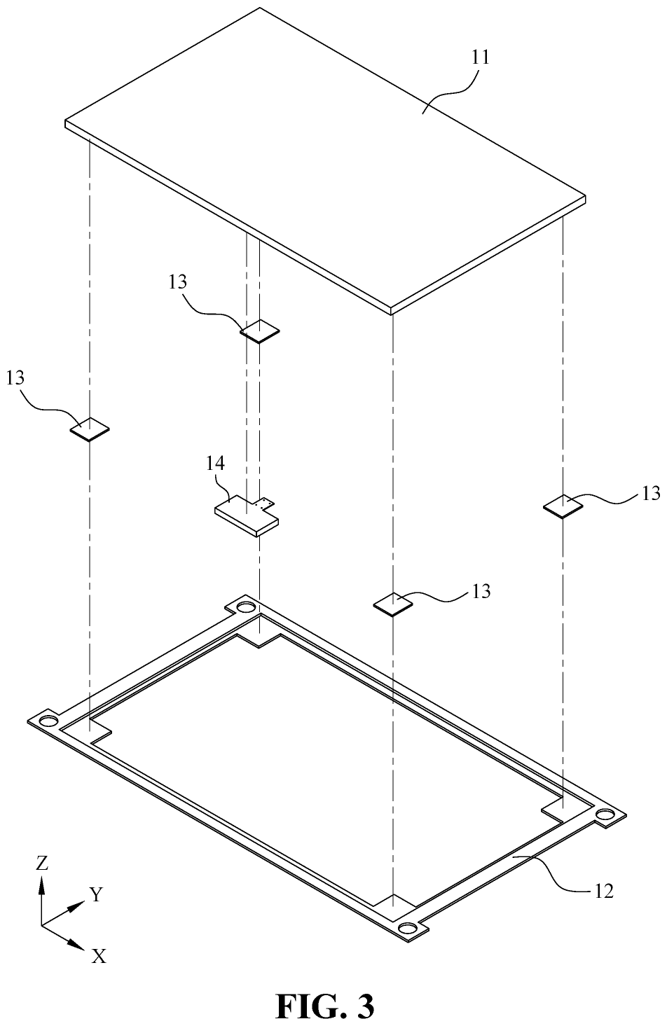

FIG. 4 is a perspective view of a first embodiment of a tactile feedback device for producing uniform vibration in an effective area of the present invention;

FIG. 5 is an exploded view of a first embodiment of a tactile feedback device for producing uniform vibration in an effective area of the present invention;

FIG. 6 is a bottom view of a first embodiment of a tactile feedback device for producing uniform vibration in an effective area of the present invention.

FIG. 7 is a bottom view of a second embodiment of a tactile feedback device for producing uniform vibration in an effective area of the present invention;

and

FIG. 8 is a bottom view of a third embodiment of a tactile feedback device for producing uniform vibration in an effective area of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

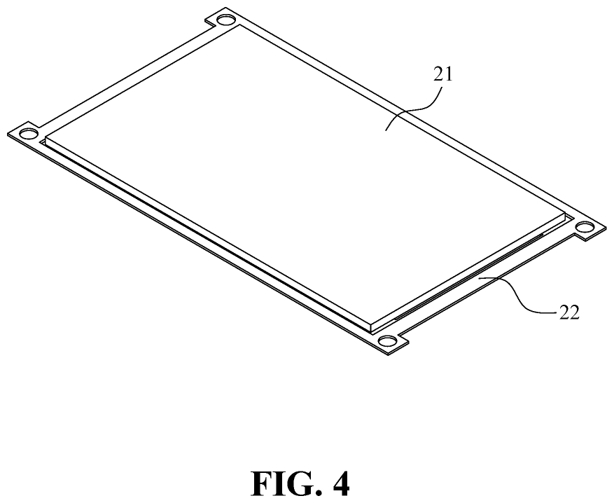

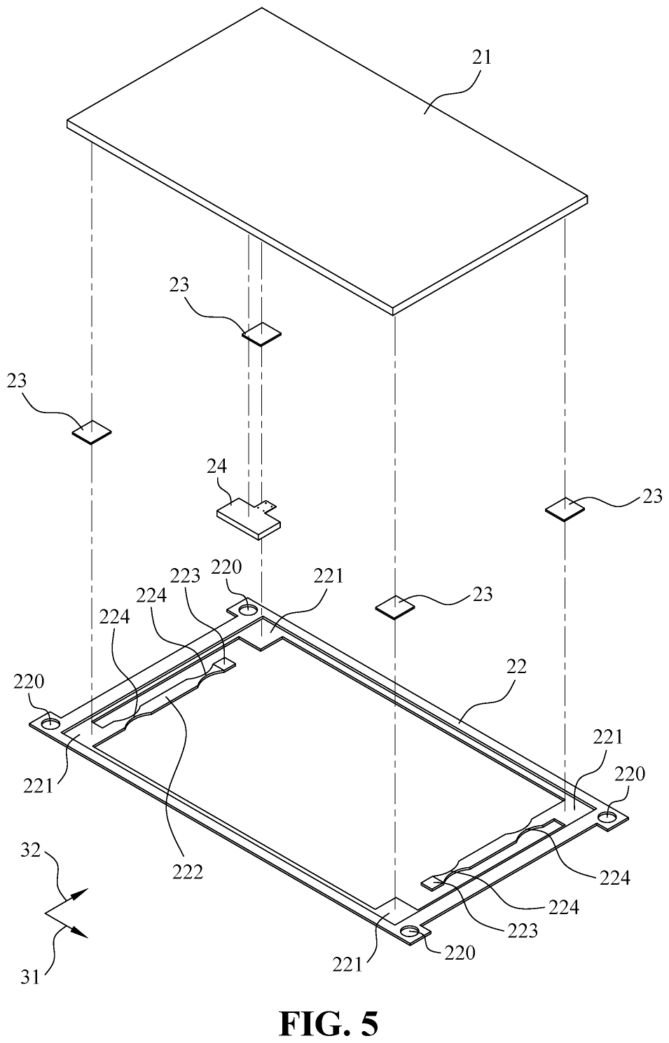

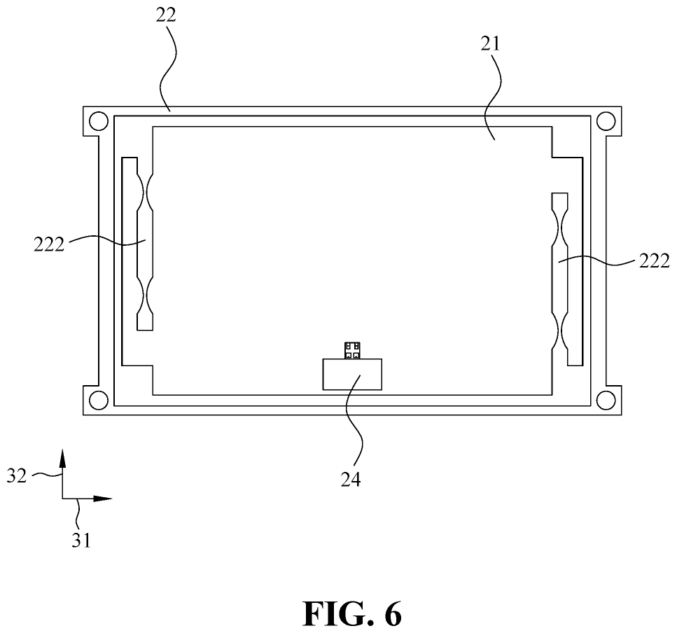

FIGS. 4, 5 and 6 show a perspective view, an exploded view and a bottom view of the first embodiment of a tactile feedback device for producing uniform vibration in an effective area of the present invention respectively. The tactile feedback device of the present invention includes: a substrate 21, a frame 22, a plurality of cushion pads 23, and a vibration motor 24. The vibration motor 24 is fixed to the substrate 21 and is off-center. The vibration motor 24 can vibrate back-and-forth in a first direction 31. The frame 22 forms a plurality of bonding areas 221 and at least a pair of cantilever beams 222. Two of the cantilever beams 222 are parallel to a second direction 32 and located on both sides of the first direction, and the second direction 32 is perpendicular to the first direction 31. The cantilever beams 222 are partially fixed to the substrate 21. The cushion pads 23 are fixed between the substrate 21 and the bonding areas 221, whereby the cushion pads 23 achieve the resonance vibration effect between the substrate 21 and the vibration motor 24 when the vibration motor 24 vibrates to meet the required vibration feedback effect. The cantilever beams 222 increase the rigidity in the Y-axis and suppress the Z-axis rotation inertia generated by the vibration motor 24 due to off-center vibration, so that the substrate 21 can maintain a uniform vibration feedback at each operation position.

The following provides a detailed description on the structure of each component:

The substrate 21 is an electronic device that can provide touch sensing, such as a touchpad, a flat keyboard, a touch screen of a tablet computer, etc., when touched with a finger, stylus or other contact interface, a corresponding electronic signals is generated, which can synchronously drive the vibration motor 24 to generate vibration, so that the operation position of the contact point can experience the tactile feedback effect of the vibration.

The frame 22 is responsible for carrying the substrate 21. In the present embodiment, the frame 22 is a rectangular frame with a slightly larger size corresponding to the shape of the substrate 21. The four corners around the frame 22 are provided with a number of coupling holes 220 for screwing the frame 22 to a base or other platforms. The frame 22 has a plurality of bonding areas 221 and at least a pair of cantilever beams 222. The number and positions of the bonding areas 221 are evenly and symmetrically distributed on the inner edge of the frame 22 for the cushioning pad 23 to be arranged. The cantilever beams 222 is connected to the frame 22 and extends to the hollow area in the frame. Two cantilever beams 222 are parallel to the second direction 32 and located on both sides of the first direction 31, wherein the second direction 32 is perpendicular to the vibration of the vibration motor 24 direction. In the present embodiment, the two cantilever beams 222 are respectively connected to two opposite sides of the frame 22 and are arranged in reverse symmetrical configuration. The cantilever beams 222 is partially adhered to the substrate 21. In the present embodiment, the end of the cantilever beams 222 away from the frame 22 is an end region 223, and the end region 223 is adhered to the substrate 21. Moreover, the cantilever beams 222 also forms at least one neck section 224 with a narrower width. In the present embodiment, there are two neck sections 224. The neck section 224 can adjust the rigidity of the cantilever beams 222 in the X-axis direction so that the cantilever beams 222 does not affect the X-axis vibration frequency of the structure during operation.

The cushioning pads 23 are fixed to the bonding area 221 and the substrate 21 by the upper and lower end surfaces respectively. As a medium for connecting the frame 22 and the substrate 21, the material of the cushioning pad 23 must help the substrate 21 and the vibration motor 24 to generate a resonance frequency, so that a huge vibration can be generated with a small periodic driving force to obtain a good vibration feedback. The material of the cushion 23 can be silicon rubber, foam, and so on.

The vibration motor 24 is fixed to the substrate 21. After being energized, the vibration motor 24 can provide repetitive back-and-forth vibration in the first direction 31, and the first direction 31 and the second direction 32 are perpendicular to each other.

To prove that each operation position of the tactile feedback device of the present invention can indeed produce uniform vibration feedback, the following related experiments were performed. In the present embodiment, the movement direction of the vibration motor 24 is the first direction, and the first direction 31 is the X-axis, the frequency is 250 Hz, the mass of the substrate 21 is about 45 g, and the vibration motor 24 is started under the condition of a voltage of 20V. After dividing the substrate 21 into nine-square grids, the vibration inductance values of each position are measured, and the following Table 3 and Table 4 can be obtained:

Table 3 is a vibration sensing measurement table for each position after the substrate 21 is divided into nine-square grids.

TABLE 3
Acceleration (Gpeak-to-peak, 1G = 9.81 m/s²)

| | | |
|---|---|---|
| 5.97 | 5.87 | 6.03 |
| 5.74 | 5.53 | 5.81 |
| 5.79 | 6.00 | 5.91 |

Table 4 is a natural frequency table of the substrate 21, wherein X is X-axis, Y is Y-axis, Z is Z-axis, ROTX is rotation around the X-axis, ROTY is rotation around the Y-axis, and ROTZ is rotation around the Z-axis.

TABLE 4

| mode of vibration | frequency(Hz) |
|---|---|
| X | 264 |
| Y | 2274 |
| Z | 408 |
| ROTX | 658 |
| ROTY | 719 |
| ROTZ | 3080 |

As shown in the above analysis results, the tactile feedback device of the present invention, because of the cantilever beams 222, the rigidity of the Y-axis and the ROTZ is increased. For example, the natural frequency of the ROTZ is adjusted to about 3000 Hz, which is 7.6 times more than the original ROTZ natural frequency and suppress the Z-axis rotational inertia generated when the vibration motor 24 vibrates. The mode of vibration in the X-axis direction still maintains at an appropriate frequency, so as to match the vibration motor 24 to generate resonance, and obtain vibration feedback of the required strength. The results are shown in Table 3. The vibration inductance measurements in nine-square grid division of the substrate 21 are evenly distributed in each grid, which effectively improves the uneven vibration degree caused by the off-center of the vibration motor 24, and meets the design requirements of such products.

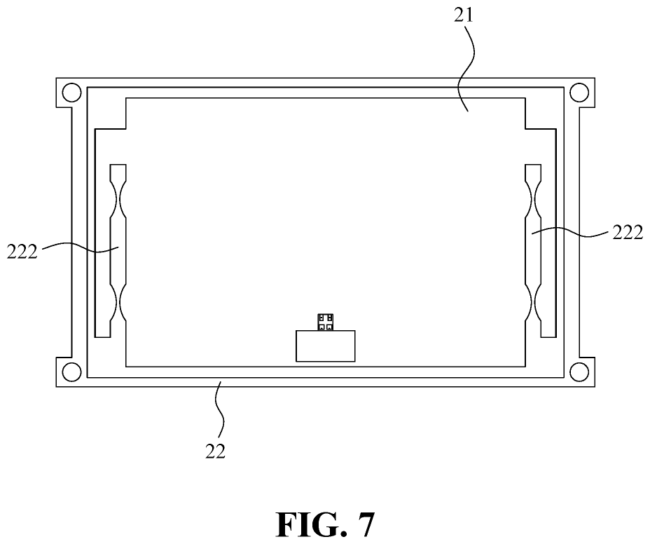

FIG. 7 shows a second embodiment of the present invention. In this embodiment, the position where the cantilever beams 222 are connected to the frame 22 is improved. As shown in FIG. 7, the two cantilever beams 222 are connected to the same side of the frame 22 and are arranged symmetrically. It can be seen that the shape, size and position of the cantilever beams 222 of the present invention are not limited to a single embodiment.

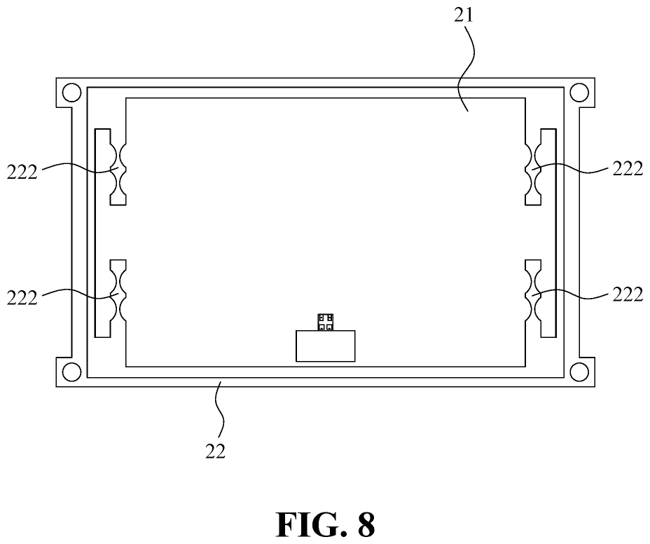

FIG. 8 shows a third embodiment of the present invention. In this embodiment, the number of the cantilever beams 222 and the position connected to the frame 22 are increased. As shown in FIG. 8, in this embodiment, there are two pairs of cantilever beams 222, and each pair of cantilever beams 222 are respectively connected to the frame 22 and located on both sides of the first direction 31 in a symmetrical configuration. It can be seen that the number of the cantilever beams 222 of the present invention is not limited to a single embodiment.

In summary, the present invention is a tactile feedback device for producing uniform vibration in an effective area, which is to dispose the cantilever beams 222 perpendicular to the vibration direction of the vibration motor 24. The cantilever beams 222 increase the rigidity, suppress the Z-axis rotational inertia, and can also maintain the frequency resonance effect required by the original vibration direction. Therefore, even if the vibration source deviates from the center position, each operating position can still obtain a uniform vibration tactile feedback, and no additional components or other complicated structures are required. As such, the present invention can maintain the original light and thin requirements, and achieve the required uniform vibration without increasing the manufacturing and production costs, which is progressive and creative, and meets the requirements of a patent application.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A tactile feedback device for producing uniform vibrations in an effective area, comprising:
a substrate;
a vibration motor, fixed on the substrate at an off-center position and able to vibrate back-and-forth in a first direction;
a frame, forming a plurality of bonding areas and at least a pair of cantilever beams, the cantilever beams being located on both sides of the first direction and parallel to a second direction, the second direction being perpendicular to the first direction, and the cantilever beams being partially fixed to the substrate; and
a plurality of cushion pads, fixed between the substrate and the bonding areas.

2. The tactile feedback device for producing uniform vibrations in an effective area according to claim 1, wherein the substrate is one of a touch panel, a flat keyboard, and a touch screen of a tablet computer.

3. The tactile feedback device for producing uniform vibrations in an effective area according to claim 1, wherein one end of the cantilever beam away from the connection with the frame is an end region, and the end region is adhered to the substrate.

4. The tactile feedback device for producing uniform vibrations in an effective area according to claim 1, wherein the cantilever beam also forms at least one neck section with a narrower width.

5. The tactile feedback device for producing uniform vibrations in an effective area according to claim 1, wherein two of the cantilever beams are connected to the two opposite sides of the frame, and are arranged in reverse symmetry.

6. The tactile feedback device for producing uniform vibrations in an effective area according to claim 1, wherein two cantilever beams are connected to the same side of the frame and are arranged symmetrically.

7. The tactile feedback device for producing uniform vibrations in an effective area according to claim 1, wherein two pairs of cantilever beams are respectively connected to the frame and located on both sides along the first direction, and are symmetrically arranged.

8. The tactile feedback device for producing uniform vibrations in an effective area according to claim 1, wherein the bonding areas are evenly and symmetrically distributed on inner edge of the frame.
